(19) United States
(12) Patent Application Publication
(10) Pub. No.: US 2006/0079276 A1
(43) Pub. Date: Apr. 13, 2006

(54) Combination wireless mouse/mobile telephone system

(75) Inventors: Auraham (Avi) Indik, Plantation, FL (US); Andrei Dacian, Pompano Beach, FL (US)

Correspondence Address: RICHARD S. ROSS, ESQ.;SUITE 3070, 4801 SOUTH UNIVERSITY DRIVE, FT. LAUDERDALE, FL, 33328, US

(73) Assignee: AURAHAM (AVI) INDIK

(21) Appl. No.: 10/959,748

(22) Filed: Oct. 7, 2004

(51) Int. Cl. H04M 1/00; G09G 5/00

(52) U.S. Cl. 455/556.1; 455/550.1

(57) ABSTRACT

A combination handheld mobile telephone and wireless mouse for navigating a Windows®-based operating system of a computer comprises a telephone battery that is transformed to accommodate the electronics of the mouse. The mouse is attached to the telephone by connecting means that replaces the original (old) telephone backing or housing with the mouse. The telephone battery is modified to provide electrical contacts, preferably on the side opposed the side that employs electrical contacts to power the telephone, to power the mouse. In this regard, the combined mobile telephone and wireless/optical mouse can run simultaneously, both drawing and sharing power from the same telephone battery.

### FIELD OF THE INVENTION

The present invention is directed to a combination wireless laser or optical mouse for navigating a monitor screen of a computer employing a Windows®-based operating system, and a wireless, mobile/cellular telephone. More particularly, the combined mouse/telephone will share the telephone battery power source.

### BACKGROUND OF THE INVENTION

People are using more and more handheld devices such as cellular or wireless telephones, laptop computers, mini-computers, and pocket computers. A majority of the relatively small sized and mobile computers whose operating systems are Windows®-based require user interaction through some sort of keyboard and mouse interface with the central processing unit (“CPU”) and computer screen monitor. These multiple, mobile communication devices and their accessories make it cumbersome to travel with due to their number and fragility. For example, when a computer user is traveling and has his/her laptop, an external mouse, due to its ergonomic construction, is preferred over the built-in cursor control device for navigating the selection of the desired computer task shown on the computer screen. Also, while traveling, an individual oftentimes needs to stay in contact with the home or office, and does this via a mobile telephone.

In order to reduce the number of accessories required for traveling when a user wants or needs to stay in contact with a home or office base, it would be convenient to combine the functions of a computer navigation mouse device and a mobile telephone. Providing additional functionality to a mobile telephone system to act as a navigation control device for a personal computer would liberate the user from requiring a separate dedicated mouse.

The combination of a mouse with a telephone has inherent obstacles however. At the present time, most optical mouses require either two AA or AAA batteries for power. Housing these external batteries onto a mouse and connecting that mouse with a telephone would make the combination commercially unacceptable. In addition, a number of telephone manufacturers provide wireless telephony components which operate using different voltages. The power to be supplied to operate the different telephone components might be insufficient or too great to power a wireless mouse device that has been combined with the telephone. Thus, the present state of wireless mouse and telephony art fails to address the needs of advancing the art by providing for a combination wireless mouse and wireless telephone device.

### SUMMARY OF THE INVENTION

A combination handheld mobile telephone and wireless mouse for navigating a computer monitor screen employing a Windows®-based operating system of a computer comprises a telephone battery that is transformed to accommodate the electronics of the mouse. The mouse is attached to the telephone by connecting means that replaces the original (old) telephone backing or housing with the mouse. The telephone battery is modified to provide electrical contacts, preferably on the side opposed the side that employs electrical contacts to power the telephone, to power the mouse. In this regard, the combined mobile telephone and wireless/optical mouse can run simultaneously, both drawing and sharing power from the same telephone battery.

It is thus an object of the present invention to provide a combination wireless mouse and wireless telephone device.

It is another object of the present invention to provide a combination wireless mouse and wireless telephone device that draws power from the same power source.

It is yet another object of the present device to provide a combination wireless mouse and wireless telephone device that draws power from a battery that powers the telephone component of the device.

It is still yet another object of the present invention to provide a wireless mouse that can comprises integrated circuitry to regulate a range of voltages.

It is but still yet another object of the present invention to provide a combination wireless mouse and wireless telephone device wherein either component can be operational independent of the other, or both components can be operational at the same time.

It is also another object of the present invention to provide an improve personal computer incorporating the combination wireless mouse and wireless telephone communication device of the present invention.

### BRIEF DESCRIPTION OF THE DRAWINGS

The above and other features and aspects of the present invention will become more apparent upon reading the following detailed description in conjunction with the accompanying drawings, in which:

FIG. 1 is a top plan view of the combination wireless mouse and wireless telephone of the present invention;

FIG. 2 is a bottom plan view of the combination wireless mouse and wireless telephone of the present invention;

FIG. 3 is a bottom plan view of the combination wireless mouse and wireless telephone of the present invention, with the mouse component removed and the telephone component battery shown;

FIG. 4 is a plan view of the representative integrated circuit shown in the interior of the wireless mouse component of the combination wireless mouse and wireless telephone of the present invention;

FIG. 5 is a right side view of the combination wireless mouse and wireless telephone of the present invention showing the right click button feature of the wireless mouse component;

FIG. 6 is a left side view of the combination wireless mouse and wireless telephone of the present invention showing the left click button feature of the wireless mouse component;

FIG. 7 is a perspective view of the combination wireless mouse and wireless telephone of the present invention;

FIG. 8 is a perspective view of a prior art USB wireless receiver of the wireless mouse transmission, that is connected to an available USB port on a central processing unit (not shown);

FIG. 9A is an enlarged plan view of the telephone battery showing the original contacts for powering the wireless telephone component of the combination wireless mouse and wireless telephone of the present invention;

FIG. 9B is an enlarged plan view of the reverse side of FIG. 9A depicting the telephone battery showing the electrical contacts for powering the wireless mouse component of the combination wireless mouse and wireless telephone of the present invention;

FIG. 9C is a block schematic representation perspective view depicting the telephone battery showing the electrical contacts for powering the wireless mouse component of the combination wireless mouse and wireless telephone of the present invention, as well as showing the electrical contacts of the wireless mouse component for engaging the telephone battery power contacts;

FIG. 10 is a schematic representation of the step up/step down converter necessary for the wireless mouse component of the present invention to draw power from a wireless telephone component battery, and;

FIG. 11 is a schematic representation of the integrated circuit board for the regulator which adapts the power from the wireless telephone component battery of the present invention.

### DETAILED DESCRIPTION OF A PREFERRED EMBODIMENT

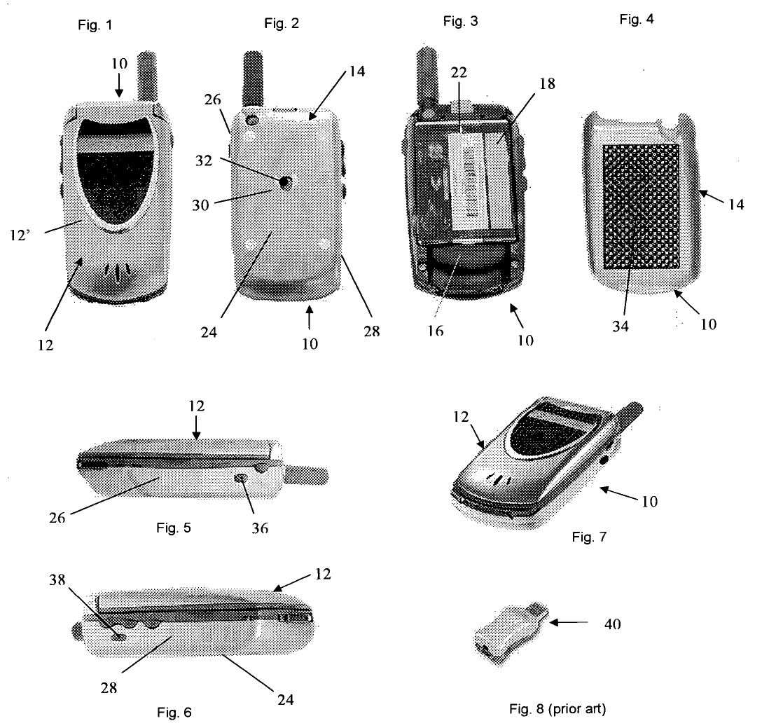

A handheld combination wireless mouse and wireless telephone communication device 10 is generally shown and depicted in FIGS. 1-7. The communication device 10 comprises the combination of a wireless telephone member 12 and a wireless mouse 14 member.

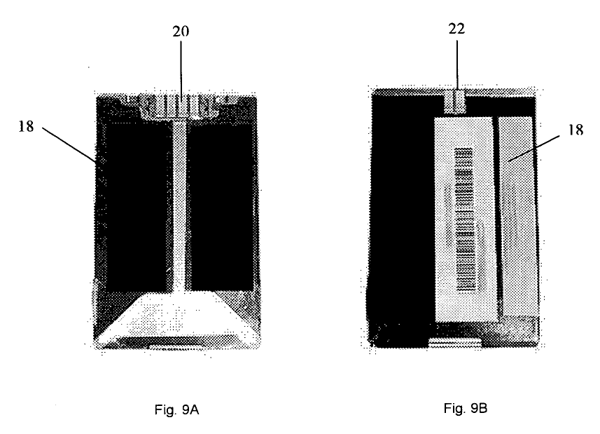

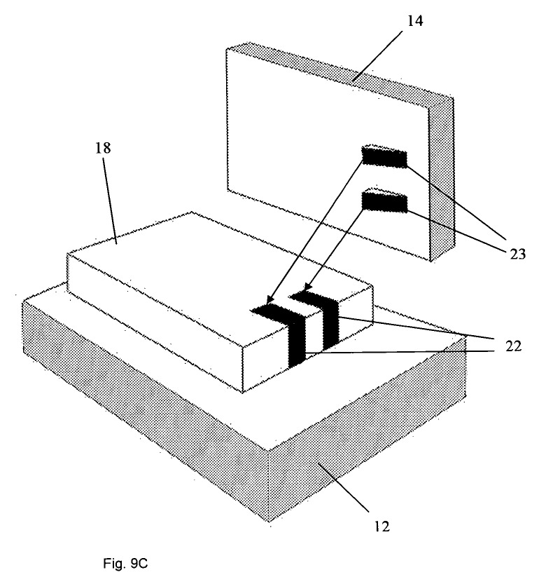

The telephone member 12 is wireless, and thus it can function in any cord-free mode, such as by cellular or satellite connection, or the like. The telephone 12 comprises a compartment 16 for housing a battery 18, which is best seen in FIG. 3. The telephone 12 also has a keypad for dialing (not shown), a front housing 12′ and a rear housing 12″ (not shown) when the communication device 10 is constructed after market from a conventional wireless telephone. The battery 18 has opposed sides. On one side of the battery 18 are electrical contacts 20 for powering the telephone 12 of the communication device 10. The opposed side of the battery 18 comprises contacts 22 for powering the mouse 14. The contacts 20 and 22 are best seen in FIGS. 9A and 9B. Additionally, FIG. 9C illustrates electrical contacts 23 on the mouse 14 for electrically engaging the contacts 22 of the battery 18.

The battery 18 of the present invention can replace the original battery provided by the telephone manufacturer when the mouse 14 of the present invention is added after market. The battery 18 of the communication device 10 is sized to complement the battery compartment 16 of the telephone 12. Once the battery 18 is installed in its compartment 16 as a substitute for the original telephone battery, by removing the rear housing 12″ of the original telephone, the mouse 14 is snapped or otherwise fitted in a releaseable locking relationship to the telephone member 12 in place of the rear housing 12″. In the preferred embodiment, the method for locking the mouse 14 to the telephone member 12 would be to employ the same locking means provided by the original telephone equipment manufacturer. In this regard, the rear housing 12″ of the original telephone would be removed and the mouse 14 would be substituted therefore. With the telephone 12 having hands-free speaker phone capability, or if it is connected to a headset/microphone, the telephone 12 and the wireless mouse 14 can be used at the same time.

The mouse 14 is further comprised of a back surface 24 which separates opposed side surfaces 26 and 28, wherein as shown in FIGS. 2, 5 and 6, side surface 26 represents the right side, and side surface 28 represents the left side of the mouse 14. The back surface 24 has an opening 30 through which means are provided for operating the mouse 14, such as an optical scanner 32. The optical scanner 32 is connected to well known mouse electronic integrated circuitry 34 and acts to navigate the cursor of a CPU monitor (not shown) employing a Windows®-based operating system. Furthermore, exposed through the right side surface 26 is a right “click” button 36 feature of the mouse 14 which permits the user to activate instructions to the CPU. Similarly, exposed through the left side surface 28 is a left “click” button 38 feature of the mouse 14 which also permits interaction between the mouse 14 and the navigated instruction provided by the user to the CPU of the personal computer which, of course, is AC or DC powered.

The mouse 14 works in conjunction with a prior art external wireless mouse receiver module 40 shown in FIG. 8 which is connected to one available universal serial bus (“USB”) port on the personal computer. The connectivity between the mouse 14 and the computer can be accomplished thru any wireless technology available, such as Bluetooth®, 27 MHz, wireless fidelity (“WiFi”), etc. However the receiver can also be built into the computer. The communication between the mouse 14 and the CPU can be facilitated by Standard HID (Human Interface Device) Windows XP drivers, so no additional software drivers needs to be provided for Windows XP (additional software drivers for other operating systems may be provided if necessary). As disclosed above, the configuration of the mouse 14 housing should accommodate the telephone 12 by having the same shape as the original telephone housing, but slightly bigger to incorporate the wireless mouse circuitry 34 (FIG. 4). The mouse 14 should be ergonomic and at the same time be able to accommodate in the right and left click buttons, 36 and 38, respectively, necessary to operate the mouse 14 (FIGS. 5 and 6).

It is contemplated that the preferred embodiment of this invention comprises the combined communication device 10. However, it is also contemplated that the mouse 14 component can be an separate add on as described. However, as might well be understood, due to the plethora of wireless telephone manufacturers, the present invention mouse component 14 must accommodate different power specifications utilized by the telephones made by the manufacturers, including, different amperages and voltages to assure the proper functionality of the telephone 12. In this regard, it is believed that in a majority of situations, manufacturers of telephones provide batteries that range from 2.7V to 5V for the voltage, and current from between approximately 200 mAh (milliAmps/hour) to 1200 mAh.

Similarly, in order to ensure proper functionality of the mouse 14, it must be able to accommodate and/or absorb additional current and voltage from the telephone battery. It is contemplated that the mouse 14 will require 3V voltage at a current of 15 mA-50 mA (depending upon whether the mouse 14 is in use or in a standby mode, i.e., when the mouse 14 is “on” and is or is not in motion, respectively), and more particularly 3V voltage at a current of 25 mA. Also, the mouse 14 can include, optionally, an on/off switch to conserve battery power when the mouse 14 is not in use.

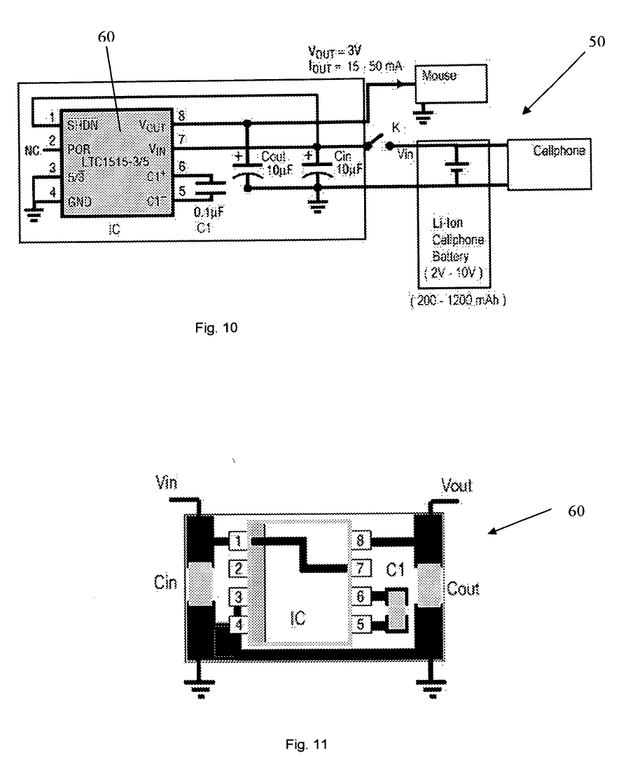

In order to accommodate the different power needs of the telephone 12 and mouse 14, a micro step-up/step-down switched capacitor DC/DC converter 50 is provided as shown in the schematic design in FIG. 10. The converter 50 works as follows: If the power from the telephone battery 18 is less then 3V, the converter 50 will raise the voltage output to 3V; if the voltage is more than 3V, and up to approximately 10V, the converter will step down and lower the voltage output to 3V, this way providing at all times the time the required voltage to power to the mouse 14.

The converter 50 includes a power interface regulator 60, shown in FIGS. 10 and 11, which adapts power from the telephone battery 18 to operate the mouse 14. This circuit interface regulator 60 will produce the 3V regulated output voltage for the mouse 14 by either stepping up or stepping down the input voltage. The regulator accommodates a wide input voltage range (2V to 10V) while maintaining ˜4% regulation. Additional circuitry prevents excessive inrush current and output voltage ripple when large voltage in (“VIN”) to voltage out (“VOUT”) differentials are present.

Regulator Operation

The power regulator 60 comprises an integrated circuit, such as that manufactured by Linear Technology LTC 1515-3/5, which acts as a charge pump, reference, comparator and some logical feedback to provide the right functionality. The divided down output voltage is compared to the internal reference voltage. When the divided output drops below the reference voltage, the charge pump is enabled, which boosts the output back into regulation. Hysteresis in the comparator forces the regulator to burst on and off and causes approximately 100 mV of peak-to-peak ripple to appear at the output. By enabling the charge pump only when needed, the integrated circuit achieves high efficiencies with low output load currents.

The charge pump has a unique architecture that allows the input voltage to be either stepped up or stepped down to produce a regulated output. Internal circuitry senses the VIN to VOUT differential voltage and controls the charge pump operating mode. In addition, the effective output impedance of the charge pump is internally adjusted to prevent large inrush currents and allow for a wide input voltage range. When the input voltage is lower than the output voltage, the charge pump operates as a step-up voltage doubler. When the input voltage is greater than the output, the charge pump operates as a step-down gated switch.

Capacitor Selection

For best performance, low equivalent series resistance (“ESR”) capacitors are recommended for both current in (“CIN”) and current out (“COUT”) to reduce noise and ripple. The CIN and COUT capacitors should be either ceramic or tantalum and should be 10 μF (microfarad). If the input source impedance is very low (<0.5Ω), CIN may not be needed. Increasing the size of COUT to 22 μF or greater will reduce output voltage ripple particularly with high VIN voltages (8V or greater). A ceramic capacitor is recommended for the flying capacitor C1 with a value of 0.1 μF or 0.22 μF.

Protection Features

All of the components of the regulator 60 contain thermal shutdown and short-circuit protection features. The components will shut down when the junction temperature reaches approximately 150° C. and will resume operation once the junction temperature has dropped back to approximately 140° C. The components will limit output current to 12 mA (typical) when a short circuit condition (VOUT<100 mV) exists. The component parts can survive an indefinite short to ground.

In all cases it is understood that the above described embodiments are merely illustrative of the many possible specific embodiments which represent applications of the present invention. Numerous and varied other arrangements can be readily devised in accordance with the principles of the present invention without departing from the spirit and scope of the invention, as defined by the accompanying claims.

What is claimed is:

1. A communication device comprising:
a Windows®-based navigation device for a central processing unit comprising a wireless mouse;
a wireless telephone member;
a power source; and,
means for releasably attaching the said mouse to said telephone.

2. The communication device of claim 1, wherein the said telephone further comprises means for operably using said mouse and said telephone at the same time.

3. The communication device of claim 2, wherein the said mouse has an on/off switch.

4. The communication device of claim 2, wherein said operable means comprises said telephone having a hands-free function.

5. The communication device of claim 2, wherein said operable means comprises a headset/microphone device connected to said telephone.

6. A communication device comprising:
a Windows®-based navigation device for a central processing unit comprising a wireless mouse;
a wireless telephone member;
a power source comprising a single battery having electrical contacts for providing power to the telephone, and also having electrical contacts for providing power to the said mouse; and,
means for releasably attaching the said mouse to said telephone.

7. The communication device of claim 6, wherein the said telephone further comprises means for operably using said mouse and said telephone at the same time.

8. The communication device of claim 7, wherein the said mouse has an on/off switch.

9. The communication device of claim 6, wherein said operable means comprises said telephone having a hands-free function.

10. The communication device of claim 6, wherein the said telephone further comprises a headset/microphone device connected to said telephone.

11. The communication device of claim 6, wherein said device comprises a step up/step down power converter.

12. The communication device of claim 11, wherein said converter includes power regulator means to regulate power to said communication device to produce a voltage of 3V at a range of 15 mA to 50 mA.

13. A Windows®-based navigation device comprising a wireless mouse that is adapted to be connectable to a wireless telephone, said mouse comprising:
scanning means;
selection means comprising right and left click buttons;
means for drawing power from a battery that powers the said telephone;
power converter means for regulating power drawn from the said battery; and,
means for releasably connecting to said telephone.

14. The wireless mouse of claim 13, wherein said power drawing means is provided by a telephone battery having a first set of electrical contacts for powering said telephone, and a second set of electrical contacts for powering said mouse, whereby said mouse includes electrical contacts for engaging said second set of electrical contacts of said battery.

15. The wireless mouse of claim 13, where said power converter is in the form of a step up/step down power converter.

16. A communication device comprising a combination wireless telephone and a Windows®-based central processing unit mouse navigation device, wherein said device further comprises a power source having a single battery with electrical contacts for providing power to the telephone, and also having electrical contacts for providing power to the mouse, and means for releasably attaching the said mouse to said telephone.

17. The communication device of claim 16, wherein the said telephone further comprises means for operably using said mouse and said telephone at the same time.

18. The communication device of claim 17, wherein the said mouse has an on/off switch.

19. The communication device of claim 16, wherein the said telephone further comprises a hands-free speaker function.

20. The communication device of claim 16, wherein the said telephone further comprises an attachable headset/microphone device.

21. The communication device of claim 16, wherein the said device further comprises power converter means.

22. A personal computer comprising:
a central processing unit;
a power source for said central processing unit;
a Windows®-based navigation device comprising a combination wireless mouse and wireless telephone, said mouse comprising scanning means, selection means comprising right and left click buttons, means for drawing power from a battery that powers the said telephone, and power converter means for regulating power drawn from the said battery; receiver means for receiving transmissions from said mouse; and, means for releasably connecting said mouse to said telephone.
